(19) United States
(12) Patent Application Publication
(10) Pub. No.: US 2025/0314116 A1
(43) Pub. Date: Oct. 9, 2025

(54) VEHICLE DOOR WITH MULTI-PURPOSE MAGNETIC ASSEMBLY

(71) Applicant: Ford Global Technologies, LLC, Dearborn, MI (US)

(72) Inventors: Asaa Harajli, Canton, MI (US); Rafic Jergess, Warren, MI (US); Christopher Matthew Radjewski, Macomb Township, MI (US); Sheng Wang, LaSalle (CA)

(21) Appl. No.: 18/625,350

(22) Filed: Apr. 3, 2024

(51) Int. Cl. E05F 15/73

(52) U.S. Cl. CPC E05F 15/73; E05Y 2900/531

(57) ABSTRACT

An assembly includes a door mounted for movement relative to a fixed vehicle structure, a magnetic member associated with at least one of the door and the fixed vehicle structure; and a magnetic receiver associated with the other of the door and the fixed vehicle structure. A control module is configured to selectively activate the magnetic member to interact with the magnetic receiver in response to at least one predetermined vehicle condition.

### TECHNICAL FIELD

This disclosure relates generally to a magnetic assembly for a vehicle door that can be configured for multiple purposes.

### BACKGROUND

During high wind speed conditions, a header region on a vehicle door may deflect outboard, which can result in noise and vibration issues.

### SUMMARY

An assembly according to an exemplary aspect of the present disclosure includes, among other things: a door mounted for movement relative to a fixed vehicle structure; a magnetic member associated with at least one of the door and the fixed vehicle structure; a magnetic receiver associated with the other of the door and the fixed vehicle structure; and a control module configured to selectively activate the magnetic member to interact with the magnetic receiver in response to at least one predetermined vehicle condition.

In a further non-limiting embodiment of the foregoing assembly, the at least one predetermined vehicle condition comprises a vehicle speed being greater than a predetermined threshold.

In a further non-limiting embodiment of any of the foregoing assemblies, the at least one predetermined vehicle condition comprises an unauthorized entry attempt.

In a further non-limiting embodiment of any of the foregoing assemblies, the at least one predetermined vehicle condition comprises a door closing event.

In a further non-limiting embodiment of any of the foregoing assemblies, the at least one predetermined vehicle condition comprises a door opening event.

In a further non-limiting embodiment of any of the foregoing assemblies, at least one bumper is associated with the magnetic member, wherein the at least one bumper is mounted with the magnetic member to the at least one of the door and the fixed vehicle structure.

In a further non-limiting embodiment of any of the foregoing assemblies, at least one bumper is associated with the magnetic member, wherein the at least one bumper is mounted to the other of the at least one of the door and the fixed vehicle structure and faces opposite the magnetic member when the door is in a closed position.

In a further non-limiting embodiment of any of the foregoing assemblies, a door seal is associated with one of the at least one of the door and the fixed vehicle structure, and wherein the magnetic member is separate from the door seal.

In a further non-limiting embodiment of any of the foregoing assemblies, the fixed vehicle structure comprises a door pillar.

In a further non-limiting embodiment of any of the foregoing assemblies, the door pillar includes an opening that receives the magnetic member, and including a power connection interface to connect the magnetic member to a power source.

In a further non-limiting embodiment of any of the foregoing assemblies, the door includes a frame portion extending around an opening for a window, and wherein the magnetic member is associated with the frame portion.

A method according to an exemplary aspect of the present disclosure includes, among other things: mounting a door mounted for movement relative to a fixed vehicle structure between an open position and a closed position; associating a magnetic member with at least one of the door and the fixed vehicle structure; associating a magnetic receiver with the other of the door and the fixed vehicle structure; and selectively activating the magnetic member to interact with the magnetic receiver in response to at least one predetermined vehicle condition.

In a further non-limiting embodiment of the foregoing method, the at least one predetermined vehicle condition comprises a vehicle speed being greater than a predetermined threshold, and the method includes activating the magnetic member when the predetermined threshold is exceeded to increase a holding force for the door when the door is in the closed position.

In a further non-limiting embodiment of any of the foregoing methods, the at least one predetermined vehicle condition comprises an unauthorized entry attempt, and the method includes activating the magnetic member when an unauthorized entry signal is received to increase a holding force for the door when the door is in the closed position.

In a further non-limiting embodiment of any of the foregoing methods, the at least one predetermined vehicle condition comprises a door closing event, and the method includes activating the magnetic member when a door closing signal is received to reduce closing effort as the door is moved toward the closed position.

In a further non-limiting embodiment of any of the foregoing methods, the at least one predetermined vehicle condition comprises a door opening event, and the method includes activating the magnetic member when a door opening signal is received to facilitate opening effort as the door is moved toward the open position.

In a further non-limiting embodiment of any of the foregoing methods, the method includes installing at least one bumper to at least one of the door and the fixed vehicle structure at a location adjacent to the magnetic member.

In a further non-limiting embodiment of any of the foregoing methods, the method includes providing a door seal on one of the door and the fixed vehicle structure, and includes mounting the magnetic member to be separate from the door seal.

In a further non-limiting embodiment of any of the foregoing methods, the fixed vehicle structure comprises a door pillar.

In a further non-limiting embodiment of any of the foregoing methods, the method includes: installing the magnetic member in an opening formed in a door pillar that comprises the fixed vehicle structure, or associating the magnetic member a frame portion extending around an opening for a window in the door; and connecting the magnetic member to a power source.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a perspective side view of a vehicle with vehicle doors in an open position, and including a magnetic member and a bumper according to one disclosed embodiment.

FIG. 2A is a front view of a vehicle door covering a door opening in a fixed vehicle structure to show a door closed position.

FIG. 2B is similar to FIG. 2A but with the vehicle door removed.

FIG. 2C is a section view of a pillar shown in FIG. 2B.

FIG. 3 is a rear view of a vehicle door with a magnetic member according to another disclosed embodiment.

FIG. 4 is a schematic illustration of a magnet member interacting with a control module and a power source.

FIG. 5 is a schematic illustration of a magnet member that is separate from a door seal.

FIG. 6 is a signal diagram showing a plurality of inputs and associated control outputs.

FIG. 7 is a logic flow diagram for a magnetic configuration in one example situation.

FIG. 8 is a logic flow diagram for a magnetic configuration in another example situation.

FIG. 9 is a logic flow diagram for a magnetic configuration in another example situation.

FIG. 10 is a logic flow diagram for a magnetic configuration in another example situation.

### DETAILED DESCRIPTION

This disclosure details a magnetic assembly for a vehicle door that can be configured for multiple purposes. For example, the magnetic assembly can be used to hold a door in place and reduce deflection during high speed wind conditions, and should be activated when a vehicle speed is above a predetermined speed. The magnetic assembly may also be scalable or calibrated to provide a variable force as needed. The magnetic assembly can also be used as a signal for a door open/closed state, can replace or be a redundancy for a door closure member ajar signal, and/or can be used as a secondary door closure member for the door.

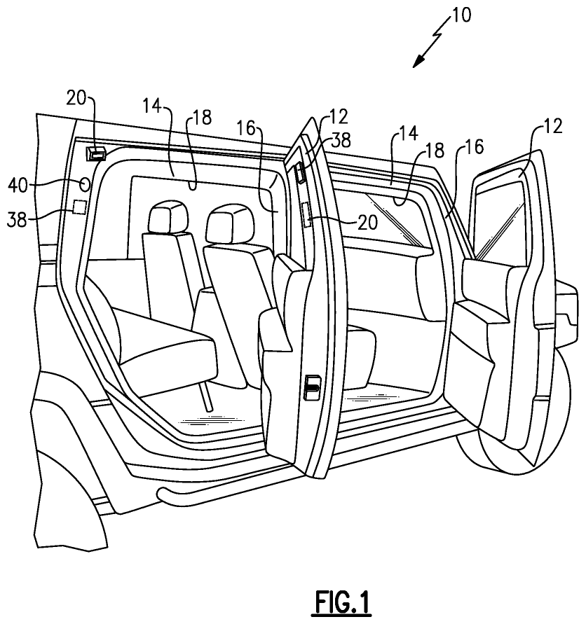

With reference to FIG. 1, a vehicle 10 includes one or more doors 12 that are moveable relative to a fixed vehicle structure 14 between open and closed positions. In one example, the fixed vehicle structure 14 comprises a frame member or door pillar 16 that surrounds a door opening 18. The doors 12 shown in FIG. 1 are in the open position.

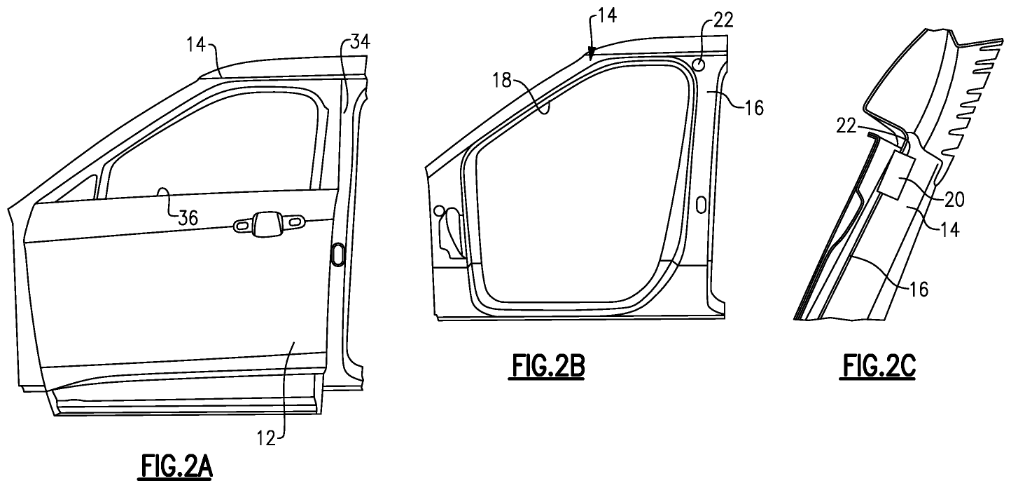

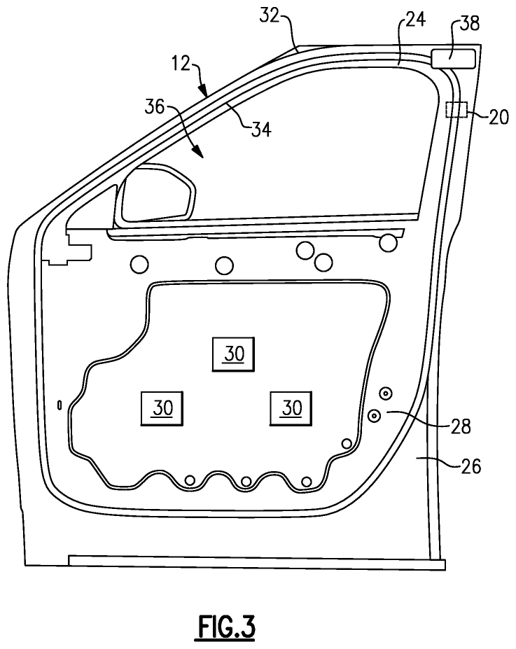

FIG. 2A shows a vehicle door 12 covering the door opening 18 in the fixed vehicle structure 14 to show a door closed position. FIG. 2B is similar to FIG. 2A but with the vehicle door 12 removed.

In each configuration, one or more magnetic members 20 are used to generate a magnetic force that interacts between the fixed vehicle structure 14 and the door 12 in response to one or more vehicle conditions. FIG. 1 shows an example where at least one magnetic member 20 is mounted to the fixed vehicle structure 14. In another configuration, at least one magnetic member 20 is mounted to the door 12 as indicated in dashed lines. Optionally, magnetic members 20 could be mounted to both the door 12 and the fixed vehicle structure 14.

FIGS. 2A-2C show an example where the magnetic member 20 is mounted to a door pillar 16. FIG. 2C is a section view of the pillar 16 shown in FIG. 2B. A hole or opening 22 is formed within the pillar 16, the magnetic member 20 is then fit within the opening 22, and is then fastened or otherwise fixed to a reinforcement area within the pillar 16. This location can provide a flat surface for the magnet to function.

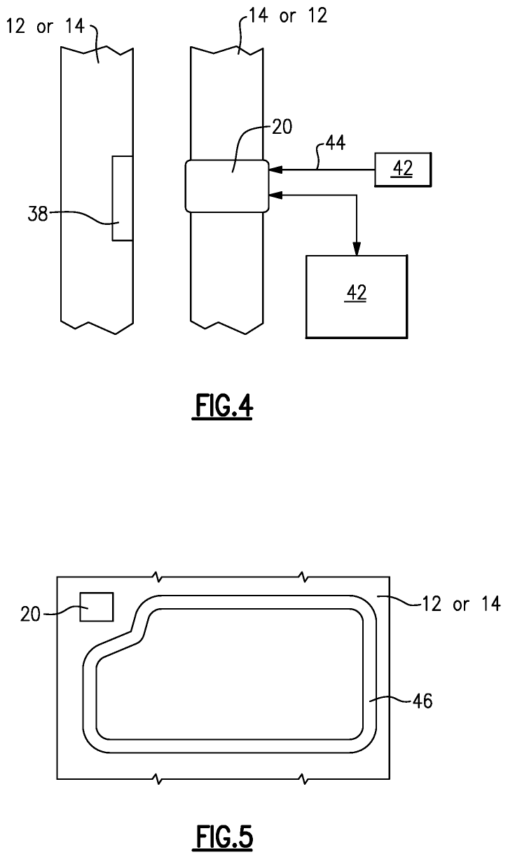

FIG. 3 shows an inside view of a door 12 where the magnetic member 20 is associated with an inner surface 24 of the door 12. In this example, the door 12 has a bottom portion 26 that includes an inner panel 28 that is associated with one or more internal door components 30, e.g., door closure member, window movement control components, etc. The door 12 also has an upper portion 32 that includes an outer frame 34 that surrounds an opening 36 for a window. In this example, the magnetic member 20 is associated with the outer frame 34.

A magnetic receiver 38 is associated with the opposing structure from which the magnetic member 20 is mounted. For example, if the magnetic member 20 is fixed to the fixed vehicle structure 14 then the magnetic receiver 38 is associated with the door 12 (see FIG. 1). Further, if the magnetic member 20 is fixed to the door 12 then the magnetic receiver 38 is associated with the fixed vehicle structure 14 (see dashed lines in FIG. 1). In one example, to provide the magnetic receiver 38, a frame around an opening of the door 12 or fixed vehicle structure 14 is magnetized by fastening magnetic material to the door 12 or fixed vehicle structure 14, or by integrating magnetic material to a molded feature that is normally attached to the door 12 or fixed vehicle structure 14. For example, a magnetic insert can be added to the inside of the door 12 or fixed vehicle structure 14 during an assembly process. Additionally, the magnetic material can be used for sheet metal/reinforcement. In another example, the magnetic receiver 38 on the opposing component can be a bolted on component, can be integrated directly into the sheet metal of the door 12 or fixed vehicle structure 14, or can be molded into a component that is attached to the door 12 or fixed vehicle structure 14.

Further, there can be a variety of interfacing systems. For example, there can be an interface between a steel door 12 to a steel body, i.e., fixed vehicle structure 14. In another example, there can be an interface between an aluminum door 12 to a steel body, i.e., fixed vehicle structure 14, and vice versa. In another example, there can be an interface between a composite material door 12 to a steel body, i.e., fixed vehicle structure 14, and vice versa.

FIG. 1 shows an example where a bumper 40 is provided to limit door movement during closing. This helps to protect the magnetic member 20. In one example, the bumper 40 is comprised of a soft and resilient material such as a foam or rubber based material, for example The bumper 40 can be integrated into the design of the magnetic member 20 so it is one assembly, or the bumper 40 can be mounted immediately near or adjacent to the magnetic member 20. The bumper 40 can also be mounted to the same structure as the magnetic member 20, i.e., door 12 or fixed vehicle structure 14, or can be mounted to the other structure, i.e., door 12 or fixed vehicle structure 14, and positioned to face the magnetic member 20 when the door 12 is in the closed position.

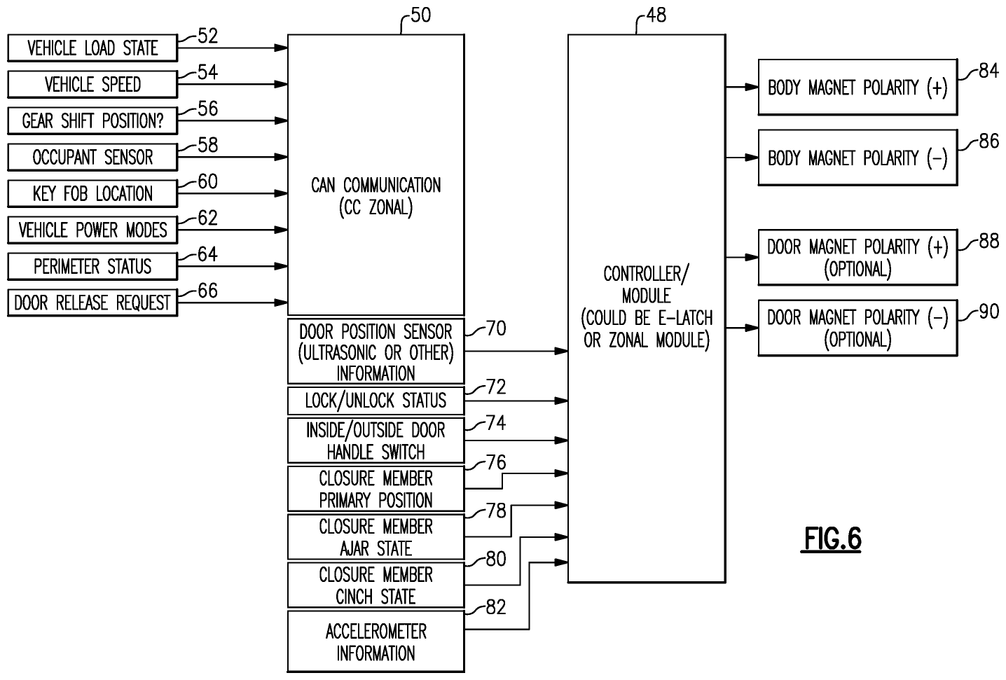

In one example, the one or more magnetic members 20 comprise electromagnets that are connected to a power source 42 via a power connection interface 44 as schematically shown in FIG. 4. In one example, the power connection interface 44 can comprise a wiring harness or can comprise a wireless interface.

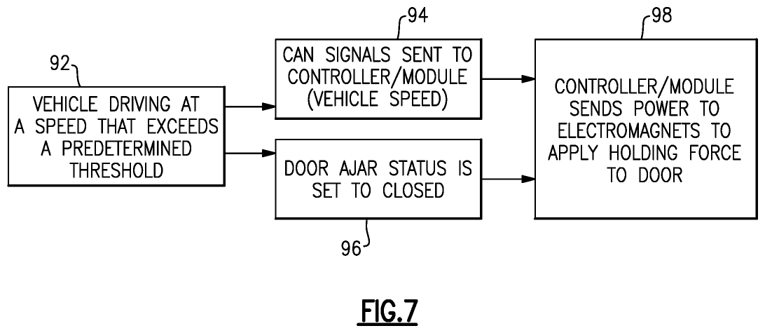

In one example shown in FIG. 5, one or more door seals 46 are associated with at least one of the door 12 and fixed vehicle structure 14. In one example, the magnetic member 20 is separate from the door seal 46. As such, the door seal 46 only provides a sealing function and the magnetic member 20 is mounted spaced from the door seal 46.

Analysis shows that aero-loads can reach over 300N near an upper portion of the window area on certain vehicle doors. During these high wind speed conditions, a header region of the door 12 may deflect in an outboard direction. If door deflection reaches a certain point, the seals 46 on the body of door can lose contact with the opposing sheet metal surface, which can result in wind ingress, vibration, and other noise conditions/issues.

To address these issues, in one example the magnetic member 20, e.g., an electromagnet, is mounted on the fixed vehicle structure 14, e.g., the vehicle body, and a magnetic receiver is mounted on the door 12 to hold the door 12 in place and reduce deflection. The reverse mounting configuration could also be used. Aero-loads that reach over 300N can translate to over 3.5 mm of door deflection. An electromagnet can provide 500N or more of holding force to overcome this wind force. Additionally, the electromagnet can be scaled or calibrated for a variable force so that more or less force gets selectively applied to hold the door 12 in place as needed.

In one example, a controller or control module 48 (FIG. 4) is configured to selectively activate the magnetic member 20 to interact with the magnetic receiver 38 in response to at least one predetermined vehicle condition. In one example, the predetermined vehicle condition comprises a vehicle speed being greater than a predetermined threshold, and a disclosed method includes activating the magnetic member 20 when the predetermined threshold is exceeded to increase a holding force for the door 12 when the door is in the closed position. For example, the magnetic member 20 can be activated if vehicle speed exceeds 25 mph.

In another example, the predetermined vehicle condition comprises an unauthorized entry attempt, and a disclosed method includes activating the magnetic member 20 when an unauthorized entry signal is received to increase a holding force for the door 12 when the door is in the closed position.

In another example, the predetermined vehicle condition comprises a door closing event, and a disclosed method includes activating the magnetic member 20 when an unauthorized entry signal is received to increase a holding force for the door 12 when the door is in the closed position.

In another example, the predetermined vehicle condition comprises a door opening event, and a disclosed method includes activating the magnetic member 20 when a door opening signal is received to facilitate opening effort as the door 12 is moved toward the open position.

In another example, the electromagnet can also be used as a signal for door open/closed state. In another example, this signal can replace, or be a redundancy for, a door closure member ajar signal. In another example, the electromagnet can be used as a secondary door closure member at a top of the door. This would be helpful for large doors, e.g., van/truck doors. Further, this simplifies the design to remove the need to package a door closure member at the top of the door, and is an efficient economic solution for a second door closure member, door presenter, double lock, etc.

In one example, the control module 48 can include a processor, memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

In one example, the control module 48 may be a hardware device for executing software, particularly software stored in memory. The control module 48 can be a custom made or commercially available processor, a central processing unit (CPU), an auxiliary processor among several processors associated with the computing device, a semiconductor based microprocessor (in the form of a microchip or chip set) or generally any device for executing software instructions.

The memory can include any one or combination of volatile memory elements and/or nonvolatile memory elements. The software in the memory may include one or more separate programs, each of which includes an ordered listing of executable instructions for implementing logical functions. The control module 48 can be configured to execute software stored within the memory, to communicate data to and from the memory, and to generally control operations of the computing device pursuant to the software. Software in memory, in whole or in part, is read by the processor and then executed.

The disclosed magnetic feature can be useful in several different aspects, in addition to overcoming door deflection during high speed wind conditions. In one example situation, such as a high input load condition, the magnetic feature can be selectively activated to help hold the door 12 in place during the high input load and then deactivated. Also, when the door is open to a certain position, the magnetic feature can be activated and remain on for a predetermined period of time to prepare the system and to help with closing efforts as a power cinching alternative. The magnetic feature can also be used as a security feature to help keep the door 12 closed in multiple regions. Further, the magnetic feature can provide a reactionary force for high energy door slam situations to protect the door and/or door closure member. For example, the control module 48 can alternate the north and south poles of the magnet member 20 to either pull or push the door 12 as needed. Thus, a force can be provided to pop door out, e.g., a door presenter alternative. Additionally, a pulsating force can be provided to counteract frequencies during NVH conditions. This can reduce NVH and wind noise issues at high-speed conditions. Other advantages are that existing modules in the vehicle can be utilized to control the magnetic member, and the magnetic member can work with multiple body construction materials and interfaces.

FIG. 6 is a signal diagram showing a plurality of inputs and associated control outputs. In this example, signals that input directly into the control module 48 are sent through a control area network (CAN) 50 communication. Input signals can comprise, for example, a vehicle input load state 52, a vehicle speed 54, a gear shift position 56 (park, drive, reverse, etc.), an occupant sensor 58, a key fob location 60, vehicle power modes 62, a perimeter status 64, a door release request 66, etc. The CAN 50 can communicate with the control module 48 as indicated at 68, and a plurality of vehicle conditions can be input into the control module 48. These plurality of vehicle conditions can include, for example, a door position sensor 70 (ultrasonic, radar, etc.), door lock/unlock status 72, inside/outside door handle switch 74, door closure member primary position 76, door closure member ajar state 78, door closure member cinch state 80, accelerometer information 82 (door closure member sensor or independent sensor), etc. The control module 48 can then use these vehicle conditions to control the magnetic members as needed to perform a desired operation. For example, in accordance with a determination of a desired operation, the control module 48 control whether the body magnet polarity is positive (see 84) or negative (see 86), and control whether the door magnet polarity is positive (see 88) or negative (see 90).

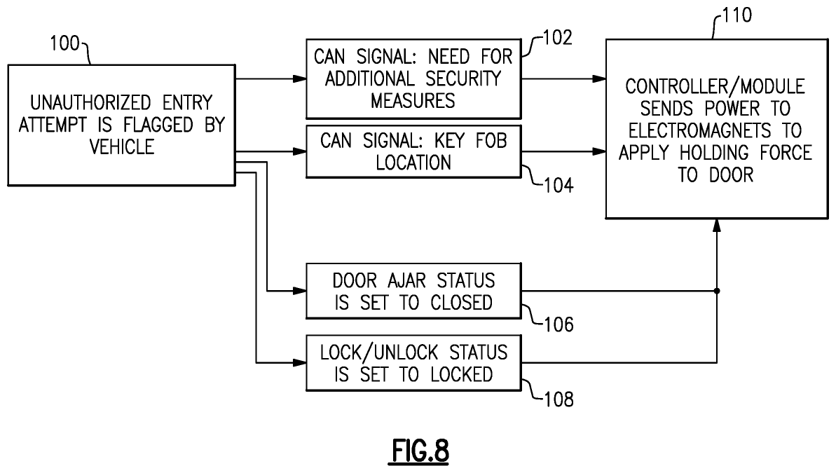

FIG. 7 is a logic flow diagram for a magnetic configuration in one example situation where the vehicle 10 is driving at high wind speeds. First, it is determined at 92 whether the vehicle 10 is driving at a speed that exceeds a predetermined speed threshold, e.g., 25 mph. If this condition is met, then CAN signals are sent to the control module 48 as indicated at 94, and a door ajar status is set to closed as indicated at 96. Then, the control module 48 sends power to the electromagnets to apply a holding force to the door as indicated at 98.

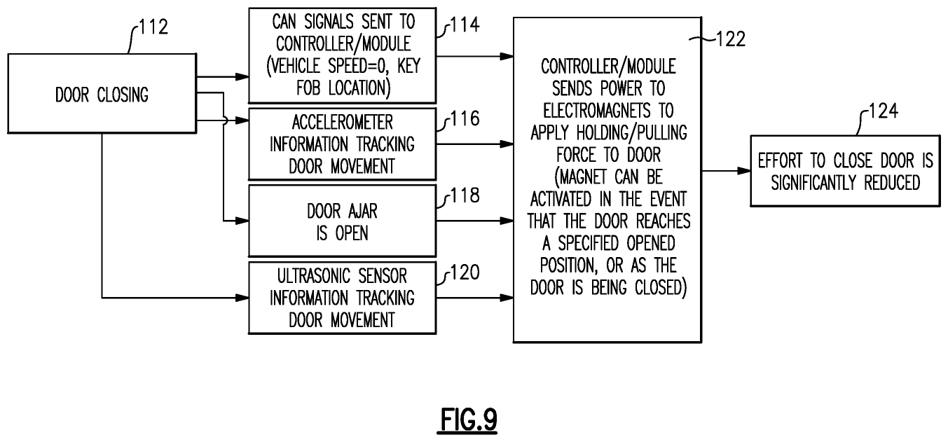

FIG. 8 is a logic flow diagram for a magnetic configuration in another example situation where there is a possible security issue. First, the control module 48 makes a determination (e.g., using one or more sensors) that there has been an unauthorized entry attempt as indicated at 100. Once this condition is triggered, then a first CAN signal 102 is sent to the control module 48 to indicate that there is a need for additional security measures and a second CAN signal 104 is sent to the control module 48 to identify a key fob location. Additionally, when this condition is triggered, the door ajar status is set to closed as indicated at 106, and the lock/unlock status is set to lock as indicated at 108. Then, the control module 48 sends power to the electromagnets to apply a holding force to the door as indicated at 110.

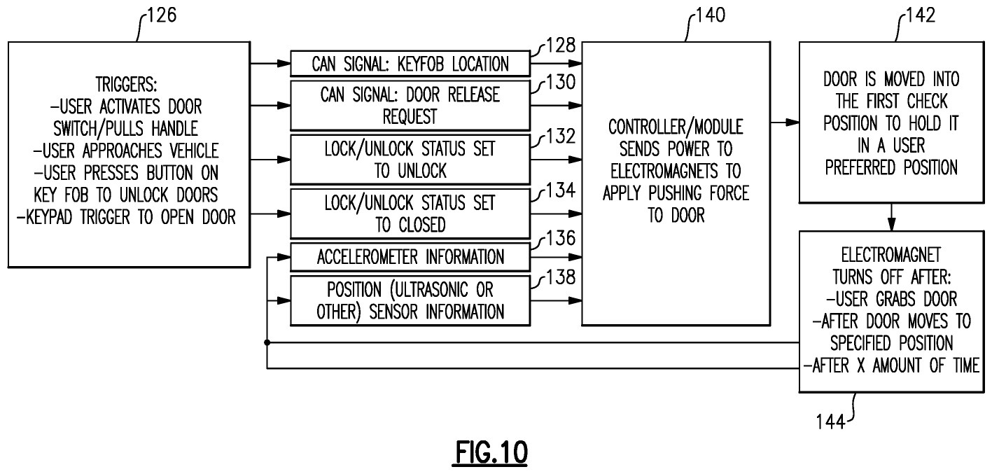

FIG. 9 is a logic flow diagram for a magnetic configuration in another example situation for a door closing event to help facilitate door closing efforts. In response to a determination that there is a door closing event 112, CAN signals are sent to the control module 48 to determine key fob location and to indicate that the vehicle speed is at zero speed (see 114). Additionally, when this condition is determined, accelerometer information tracking door movement is input to the control module 48 as indicated at 116, the door ajar status is set to open as indicated at 118, and sensor information tracking door movement is input to the control module 48 as indicated at 120. Then the control module 48 sends power to the electromagnets to apply a holding/pulling force to the door as indicated at 122, which significantly reduces the effort needed to close the door as indicated at 124. In one example, the magnets can be activated in the event that the door reaches a specified opened position, or as the door is being closed.

FIG. 10 is a logic flow diagram for a magnetic configuration in another example situation that provides a door presenter feature. First, it is determined if a door presenter event is triggered as indicated at 126. These triggers can include, for example, a user activating a door switch or pulling a handle, a user approaching the vehicle, a user pressing an unlock button on a key fob, using a keypad or other type of input code to open the door, etc. Once this condition is triggered, then a first CAN signal 128 is sent to the control module 48 to identify a key fob location, and a second CAN signal 130 is sent to the control module 48 to indicate the door release request. Additionally, when this condition is triggered, the lock/unlock status is set to unlock as indicated at 132, the door ajar status is set to closed as indicated at 134, accelerometer door information is sent to the control module 48 as indicated at 136, and position information (ultrasonic or other sensor) is sent to the control module 48 as indicated at 138. Then, the control module 48 sends power to the electromagnets to apply a pushing force to the door as indicated at 140. The door 12 can then be moved into a first check position (e.g., user preferred position) as indicated at 142, and then the electromagnets turn off (see 144) after the user grabs the door, the door moves to a specified position, or after a predetermined amount of time.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. An assembly, comprising:
a door mounted for movement relative to a fixed vehicle structure;
a magnetic member associated with at least one of the door and the fixed vehicle structure;
a magnetic receiver associated with the other of the door and the fixed vehicle structure; and
a control module configured to selectively activate the magnetic member to interact with the magnetic receiver in response to at least one predetermined vehicle condition.

2. The assembly of claim 1, wherein the at least one predetermined vehicle condition comprises a vehicle speed being greater than a predetermined threshold.

3. The assembly of claim 1, wherein the at least one predetermined vehicle condition comprises an unauthorized entry attempt.

4. The assembly of claim 1, wherein the at least one predetermined vehicle condition comprises a door closing event.

5. The assembly of claim 1, wherein the at least one predetermined vehicle condition comprises a door opening event.

6. The assembly of claim 1, including at least one bumper associated with the magnetic member, wherein the at least one bumper is mounted with the magnetic member to the at least one of the door and the fixed vehicle structure.

7. The assembly of claim 1, including at least one bumper associated with the magnetic member, wherein the at least one bumper is mounted to the other of the at least one of the door and the fixed vehicle structure and faces opposite the magnetic member when the door is in a closed position.

8. The assembly of claim 1, including a door seal associated with one of the at least one of the door and the fixed vehicle structure, and wherein the magnetic member is separate from the door seal.

9. The assembly of claim 1, wherein the fixed vehicle structure comprises a door pillar.

10. The assembly of claim 9, wherein the door pillar includes an opening that receives the magnetic member, and including a power connection interface to connect the magnetic member to a power source.

11. The assembly of claim 1, wherein the door includes a frame portion extending around an opening for a window, and wherein the magnetic member is associated with the frame portion.

12. A method comprising:
mounting a door mounted for movement relative to a fixed vehicle structure between an open position and a closed position;
associating a magnetic member with at least one of the door and the fixed vehicle structure;
associating a magnetic receiver with the other of the door and the fixed vehicle structure; and
selectively activating the magnetic member to interact with the magnetic receiver in response to at least one predetermined vehicle condition.

13. The method of claim 12, wherein the at least one predetermined vehicle condition comprises a vehicle speed being greater than a predetermined threshold, and including activating the magnetic member when the predetermined threshold is exceeded to increase a holding force for the door when the door is in the closed position.

14. The method of claim 12, wherein the at least one predetermined vehicle condition comprises an unauthorized entry attempt, and including activating the magnetic member when an unauthorized entry signal is received to increase a holding force for the door when the door is in the closed position.

15. The method of claim 12, wherein the at least one predetermined vehicle condition comprises a door closing event, and including activating the magnetic member when a door closing signal is received to reduce closing effort as the door is moved toward the closed position.

16. The method of claim 12, wherein the at least one predetermined vehicle condition comprises a door opening event, and including activating the magnetic member when a door opening signal is received to facilitate opening effort as the door is moved toward the open position.

17. The method of claim 12, including installing at least one bumper to at least one of the door and the fixed vehicle structure at a location adjacent to the magnetic member.

18. The method of claim 12, including providing a door seal on one of the door and the fixed vehicle structure, and including mounting the magnetic member to be separate from the door seal.

19. The method of claim 12, wherein the fixed vehicle structure comprises a door pillar.

20. The method of claim 12, including:
installing the magnetic member in an opening formed in a door pillar that comprises the fixed vehicle structure, or associating the magnetic member a frame portion extending around an opening for a window in the door; and
connecting the magnetic member to a power source.
